(19) United States
(12) Patent Application Publication
(10) Pub. No.: US 2004/0221879 A1
(43) Pub. Date: Nov. 11, 2004

(54) Motor-integrated pump and washing apparatus using the same

(75) Inventors: Yoshifumi Tanabe, Tagata-gun (JP); Takahiko Manda, Mishima-shi (JP); Kazunori Murakami, Tagata-gun (JP); Toshiyasu Takura, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Toshiba Tec Kabushiki Kaisha, Tokyo (JP)

(21) Appl. No.: 10/836,361

(22) Filed: Apr. 29, 2004

(30) Foreign Application Priority Data
May 7, 2003 (JP) JP2003-128599

(51) Int. Cl. B08B 3/00

(52) U.S. Cl. 134/58 D; 134/184; 134/186; 134/200

(57) ABSTRACT

A first suction port communicates with one open side of a stator, and an outlet communicates with the other open side of the stator. A rotor fixed to forward and reverse rotatable rotation shaft is contained inside the stator. The rotor has a spiral flow channel on its outer peripheral surface to suck fluid from the first suction port and discharge the fluid to the outlet along with forward rotation. A pump chamber surrounding the rotation shaft and communicating with a second suction port and a discharge port, is provided on one open side of the stator. An impeller to suck the fluid from the second suction port and discharge the fluid to the discharge port along with the forward rotation is fixed in the rotation shaft inside the pump chamber. The impeller comprises a first pressing surface to press the fluid in the pump chamber in the same direction as the thrust load acting on the rotation shaft along with the forward rotation of the rotor. Depressing the fluid with the first pressing surface offsets the thrust load acting on the rotation shaft and in this way reduces wear on the bearings of the rotation shaft.

### CROSS REFERENCE TO RELATED APPLICATION

The present application is based on Japanese Priority Document P2003-128599 filed on May 7, 2003, the content of which is incorporated herein by reference.

### BACKGROUND OF THE INVENTION

1. Field of the Invention

The present invention relates to a motor-integrated pump and a washing apparatus housing the motor-integrated pump.

2. Discussion of the Background

Motor-integrated pumps where a motor and a pump are integrated are known in the conventional art. Japanese Unexamined Patent Publication No. Hei 10-246193 discloses a motor-integrated pump where a rotor is operated as an impeller.

A motor-integrated pump is mounted for example in a washing apparatus such as a dish washer. Japanese Unexamined Patent Publication No. 2001-78948 discloses a pump where a washing pump and a discharge pump are connected to a motor rotation shaft. In this pump, when the motor is rotated in one direction (forward rotation), the washing pump operates. Washing water in a washing tank is sucked and discharged toward dishes by water pump operation and the dishes are in this way washed. After completion of washing, the motor is rotated in the other direction (reverse rotation). The discharge pump is driven by the motor in the other direction (reverse direction). The washing water in the washing tank is sucked and discharged outside the dish washer by the discharge pump.

In the pump disclosed in Japanese Unexamined Patent Publication No. 2001-78948, when the washing water is discharged toward the dishes or when the washing water is discharged outside the dish washer, a thrust load is imposed on the rotation shaft of the motor. The problem occurs that the bearing of the rotation shaft deteriorates due to the thrust load and the life of the pump is shortened. The problem of the bearing deteriorating due to the thrust load is more serious during dishwashing compared to that during wash water discharging, since the time of continuous operation during washing is longer during discharging.

### SUMMARY OF THE INVENTION

It is an object of the present invention to reduce the thrust load exerted on the rotation shaft so that the durability of the bearing supporting the rotation shaft can be improved.

The present invention provides a motor-integrated pump comprising:

a cylindrical stator having a plurality of coil wires;

a first suction port communicating with one open side of the stator;

an outlet communicating with the other open side of the stator;

a rotation shaft rotatably supported by a pair of bearings so as to pass through inside the stator;

a rotor capable of rotating in forward and reverse directions within the stator and fixed to the rotation shaft;

a flow channel formed in a spiral shape on an outer peripheral surface of the rotor to suction fluid from the first suction port and discharge the fluid to the outlet along with the forward rotation of the rotor;

a pump chamber separated by a partition wall from the first suction port on one open side of the stator and surrounding the rotation shaft;

a second suction port communicating with the pump chamber;

a discharge port communicating with the pump chamber;

an impeller fixed to the rotation shaft in the pump chamber;

a first pressing surface provided on the impeller to press the fluid in the pump chamber in the same direction as the direction of the thrust load exerted on the rotation shaft along with the forward rotation of the rotor; and

a second pressing surface provided on the impeller to suck the fluid from the second suction port and discharge the fluid to the discharge port along with the reverse rotation of the impeller.

The present invention further provides a washing apparatus comprising:

a container to contain an object to be washed;

a nozzle body provided below the container and provided with a plurality of nozzles to discharge washing water;

a washing water tank positioned below the container;

a discharge tank positioned below the container;

a motor-integrated pump comprising:

a cylindrical stator having a plurality of coil wires;

a first suction port communicating with a lower open side of the stator;

an outlet communicating with an upper open side of the stator;

a rotation shaft rotatably supported by a pair of bearings so as to pass through inside the stator;

a rotor capable of rotating in forward and reverse directions within the stator and fixed to the rotation shaft;

a flow channel provided in a spiral shape on an outer peripheral surface of the rotor to suck fluid from the first suction port and discharge the fluid to the outlet along with the forward rotation of the rotor;

a pump chamber separated by a partition wall from the first suction port on one open side of the stator and enclosing the rotation shaft;

a second suction port communicating with the pump chamber;

a discharge port communicating with the pump chamber;

an impeller fixed to the rotation shaft in the pump chamber;

a first pressing surface provided on the impeller to press the fluid in the pump chamber in the same direction as a direction of thrust load exerted on the rotation shaft along with the forward rotation of the rotor; and

a second pressing surface provided on the impeller to suck fluid from the second suction port and discharge the fluid to the discharge port along with reverse rotation of the impeller;

a first suction pipe connecting the washing water tank with the first suction port;

a supply pipe connecting the outlet with the nozzle body; and

a second suction pipe connecting the discharge tank with the second suction port.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a longitudinal cross-sectional view showing the entire structure of a dish washer according to an embodiment of the present invention;

FIG. 2 is a longitudinal cross-sectional view showing an enlarged part of the dish washer;

FIG. 3 is a cross-sectional view along a line A-A in FIG. 2;

FIG. 4 is a cross-sectional view along a line B-B in FIG. 2;

FIG. 5 is a plan view in an arrow C direction in FIG. 2;

FIG. 6 is a plan view in an arrow D direction in FIG. 2;

FIG. 7 is a cross-sectional view along an line E-E in FIG. 6;

FIG. 8 is a perspective view of an impeller;

FIG. 9 is a longitudinal cross-sectional view showing a resin bearing supporting an upper end of a rotation shaft; and

FIG. 10 is a longitudinal cross-sectional view showing a resin bearing supporting a lower end of the rotation shaft.

### DETAILED DESCRIPTION OF THE PREFERRED EMBODIMENTS

A preferred embodiment of the present invention will now be described in accordance with the accompanying drawings. The embodiment is an example applying the present invention to a dish washer 1.

The dish washer 1 contains a dish container 4 to hold dishes 3 placed in a dish basket 2. A nozzle body 6 provided with a plurality of nozzles 5 to discharge washing water, a washing water tank 7 arranged below the nozzle body 6, and a discharge tank 8 arranged below the washing water tank 7 are provided below the dish container 4. The dish washer 1 contains a motor-integrated pump 9 with a function for discharging the washing water in the washing water tank 7 from the nozzles 5 and a function for discharging the washing water in the discharge tank 8 outside the dish washer 1. The dish washer 1 is connected to a water pipe (not shown) to supply washing water. An openable and closable door 10 for taking the dishes 3 in and out of the dish container 4 is arranged on the front part of the dish washer 1.

The motor-integrated pump 9 has a housing 12 accommodating a cylindrical stator 11. A rotor 13 capable of forward and reverse rotation is stored inside the stator 11. The rotor 13 is fixed to a rotation shaft 14 rotatably supported in the housing 12. An impeller 15 is also fixed to the rotation shaft 14. The impeller 15 is arranged under the rotor 13 and housed in the housing 12. An upper part of the motor-integrated pump 9 is defined as a first pump unit 16, and a lower part of the pump is defined as a second pump unit 17.

A spiral flow channel 18 is formed on the periphery of the rotor 13 from one end to the other end of the rotor 13. A centrifugal impeller 13a is integrally formed with an upper end of the rotor 13. A plurality of permanent magnets (not shown) provided with their ends facing the inner peripheral surface are provided in the rotor 13.

The stator 11 has a cylindrical stator core 19 formed by laminating silicon steel plates. Six convex members 20 are integrally formed with the inner peripheral side of the stator core 19 at equal intervals in a radial pattern. Each convex member 20 is bound with a coil wire 21. The gap between the convex member 20 and the coil wire 21 is insulated with a bobbin 22.

A thin cylindrical can 23 formed with nonmagnetic material such as aluminum or SUS is attached on the inner peripheral side of the stator 11. Silicone grease as a viscous heat conducting member is filled between the can 23 and the stator 11. The silicone grease ensures good heat conduction between the stator 11 and the can 23. The can 23 keeps the stator 11 water-proof. An O ring 24 is provided between an upper end of the can 23 and the housing 12. An O ring 25 is provided between a lower end of the can 23 and the housing 12.

An upper case 26 covering an upper part of the centrifugal impeller 13a is fixed to an upper end of the housing 12. The space around the centrifugal impeller 13a in the upper case 26 is formed as a pressure chamber 27.

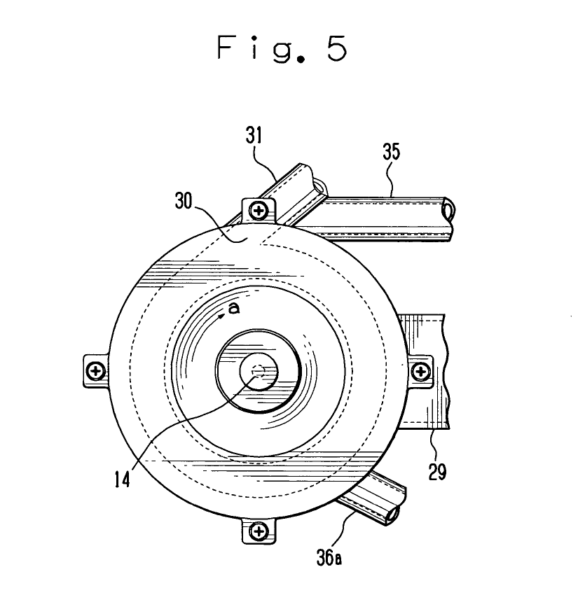

A first suction port 28 to suck the washing water (fluid) into the can 23 when the rotor 13 rotates forward (rotates in a clockwise direction as viewed from an upper position) is arranged in a lower end portion of the housing 12. The first suction port 28 is connected via a first suction pipe 29 to the washing water tank 7. An outlet 30 (refer FIG. 5) to discharge the washing water that was sucked from the first suction port 28 and then rose along the flow channel 18 and entered the pressure chamber 27, is provided in the pressure chamber 27. The outlet 30 is connected via a supply pipe 31 to the nozzle body 6.

A lower case 32 covering the impeller 15 is fixed to a lower end of the housing 12. The space around the impeller 15 in the lower case 32 is formed as a pump chamber 33.

A second suction port 34 to sucked the washing water (fluid) into the pump chamber 33 when the rotor 13 rotates in reverse (rotates counterclockwise as viewed from the upper position) is provided in the pump chamber 33. The second suction port 34 is connected via a second suction pipe 35 to the discharge tank 8. A discharge port 36 to discharge the washing water sucked from the second suction port 34 is arranged in the pump chamber 33. The discharge port 36 is connected to a discharge pipe 36a to discharge the washing water outside the dish washer 1.

The first pump unit 16 comprises the stator 11, the rotor 13, the upper case 26, the pressure chamber 27, the first suction port 28 and the outlet 30. The second pump unit 17 comprises the impeller 15, the lower case 32, the pump chamber 33, the second suction port 34 and the discharge port 36. The first pump unit 16 and the second pump unit 17 are separated by a partition plate 37 as a partition wall. The partition plate 37 separates the pump chamber 33 from the first suction port 28. The rotation shaft 14 passes through the partition plate 37. The partition plate 37 provides a communicating hole 38 formed around the rotation shaft 14 so as to connect the can 23 with the pump chamber 33. An aperture is provided between the outer edge of the communicating hole 38 and the rotating shaft 14. The aperture is formed in a size approximately to prevent passage of residue that might clog in the nozzles 5.

FIG. 8 is a perspective view of the impeller 15. The impeller 15 has six blades 39 as shown in FIG. 8. Each blade 39 has a first pressing surface 39a and a second pressing surface 39b.

In the dish washer 1 of the present embodiment, when the rotor 13 rotates forward, the washing water sucked from the first suction port 28 rises in the flow channel 18. The washing water is discharged from the outlet 30, and ejected from the nozzles 5 of nozzle body 6 thereby washing the dishes 3. During dishwashing, the pressure in the pressure chamber 27 is increased along with the forward rotation of the rotor 13, and this imposes a downward thrust load on the rotation shaft 14.

The first pressing surface 39a has a slope to press the washing water in the pump chamber 33 in a downward direction along with forward rotation of the impeller 15 (rotation in direction of the arrow a in FIG. 8) with the rotor 13. The downward direction is the same as the direction of the thrust load acting on the rotation shaft 14. As the impeller 15 rotates in a forward direction and the first pressing surface 39a presses the washing water in the pump chamber 33 downward, a counteraction from the pressing of the fluid by the first pressing surface 39a acts upwardly on the impeller 15. The upward counteraction and the downward thrust load acting on the rotation shaft 14 in this way offset each other, and the thrust load acting on the rotation shaft 14 can therefore be reduced. As a result, the load acting on resin bearings 40 and 41 supporting the rotation shaft 14 can be reduced.

The second pressing surface 39b is formed in a direction to collide with the washing water in the pump chamber 33 at an approximately right angle and press the washing water to the discharge port 36 when the impeller 15 rotates in reverse (rotation in direction of the arrow b in FIG. 8) with the rotor 13.

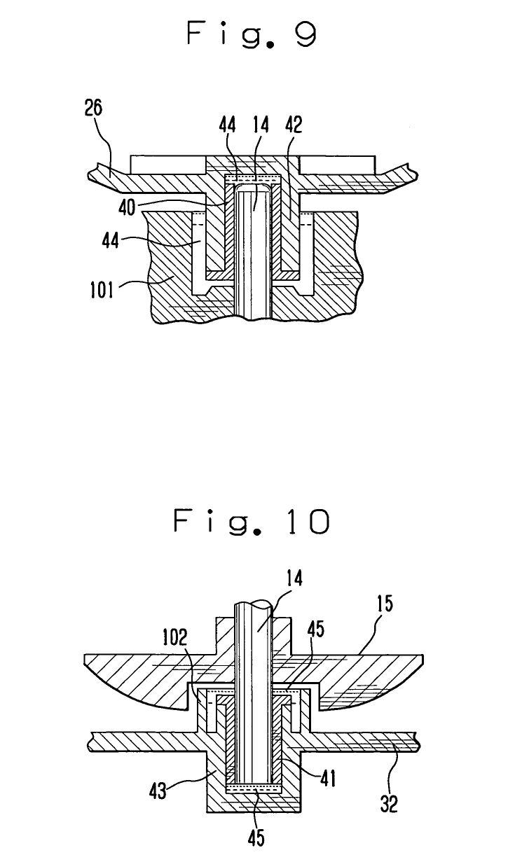

FIG. 9 is a longitudinal cross-sectional view showing the resin bearing 40 supporting an upper end of the rotation shaft 14. FIG. 10 is a longitudinal cross-sectional view showing the resin bearing 41 supporting a lower end of the rotation shaft 14. The both upper and lower ends of the rotation shaft 14 are respectively supported by the resin bearings 40 and 41. The resin bearing 40 on the upper end side is held with a holder 42 projecting from the upper case 26. The resin bearing 41 on the lower end side is held with a holder 43 formed in the lower case 32. The resin bearings 40 and 41 are made of a resin such as fluorine-contained resin or carbon-contained polymers.

As shown in FIG. 9, a reservoir 44 to hold the washing water as a lubricant is formed around the resin bearing 40. The reservoir 44 is formed in a space between an upper convex member 101 formed to enclose the resin bearing 40 on the upper surface of the rotor 13 and the holder 42. The washing water held in the reservoir 44 infiltrates in a space between the outer surface of the rotation shaft 14 and the inner surface of the resin bearing 40 by a capillary phenomenon and thereby lubricates a sliding surface between the resin bearing 40 and the rotation shaft 14. The washing water infiltrated between the rotation shaft 14 and the resin bearing 40 by the capillary phenomenon is further held in space between the bottom surface of the upper case 26 and the upper end of the rotation shaft 14. This space therefore also becomes the reservoir 44. The washing water held in the reservoir 44 formed in the space between the bottom surface of the upper case 26 and the upper end of the rotation shaft 14 also contributes to the lubrication between the rotation shaft 14 and the resin bearing 40.

As shown in FIG. 10, a reservoir 45 to reserve the washing water as a lubricant is formed around the resin bearing 41. The reservoir 45 is formed with a lower convex member 102 formed to surround the resin bearing 41 in the bottom surface of the lower case 32. The washing water held in the reservoir 45 infiltrates between the rotation shaft 14 and the resin bearing 41 by a capillary phenomenon, thereby lubricating a sliding surface between the resin bearing 41 and the rotation shaft 14. The washing water infiltrated in a space between the outer surface of the rotation shaft 14 and the inner surface of the resin bearing 41 by the capillary phenomenon is further held in space between the bottom surface of the lower case 32 and the lower end of the rotation shaft 14. This space therefore also becomes the reservoir 45. The washing water held in the reservoir 45 formed in the space between the bottom surface of the lower case 32 and the lower end of the rotation shaft 14 also contributes to the lubrication between the rotation shaft 14 and the resin bearing 41.

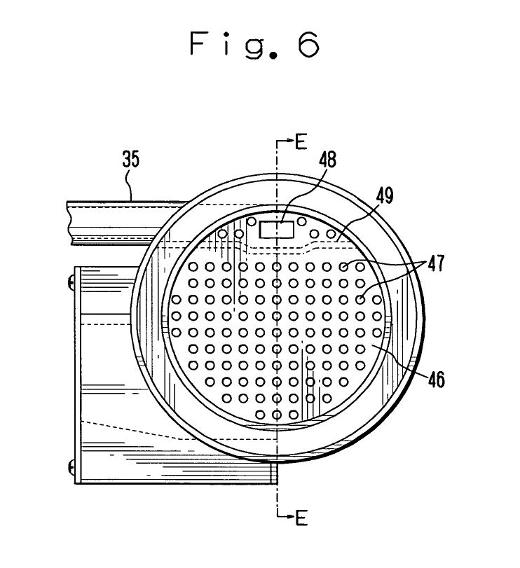

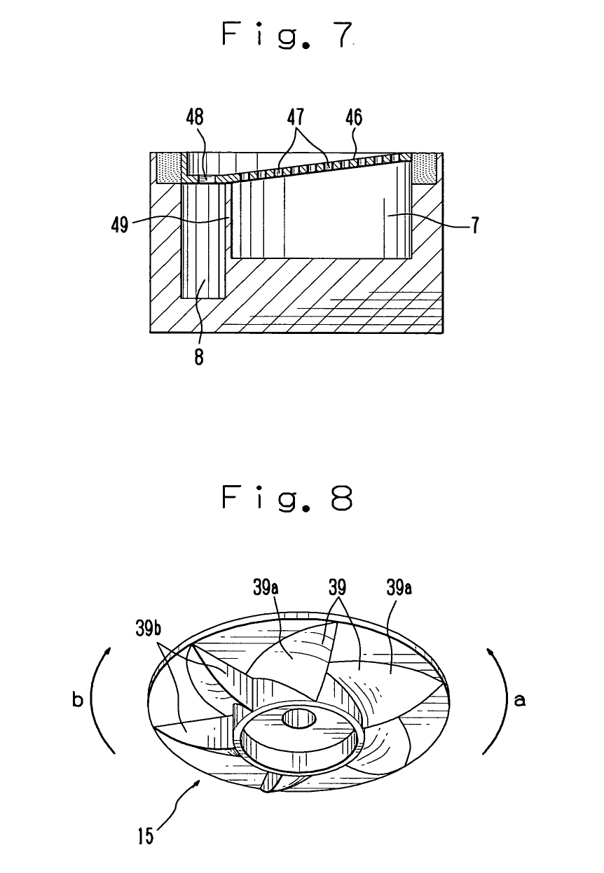

As shown in FIGS. 6 and 7, a slanted filter 46 is arranged above the washing water tank 7. The filter 46 comprises a plurality of washing water holes 47 that allow the washing water to pass but prevent the passage of residue. The filter 46 also comprises a residua hole 48 positioned on the downstream side along a slant direction of the filter 46 to pass the residue.

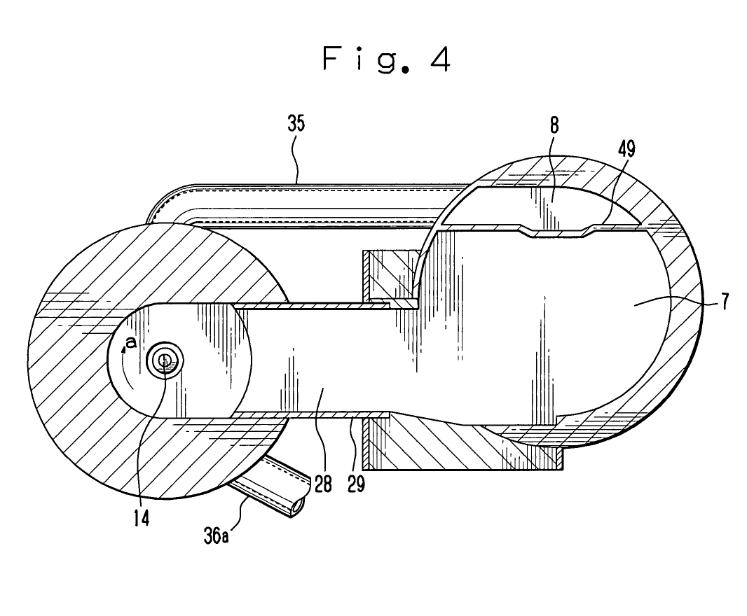

As shown in FIGS. 4 and 6, the washing water tank 7 and the discharge tank 8 are separated by a rib 49. The washing water tank 7 and the discharge tank 8 connect with each other when the water level of the washing water is higher than the upper end of the rib 49.

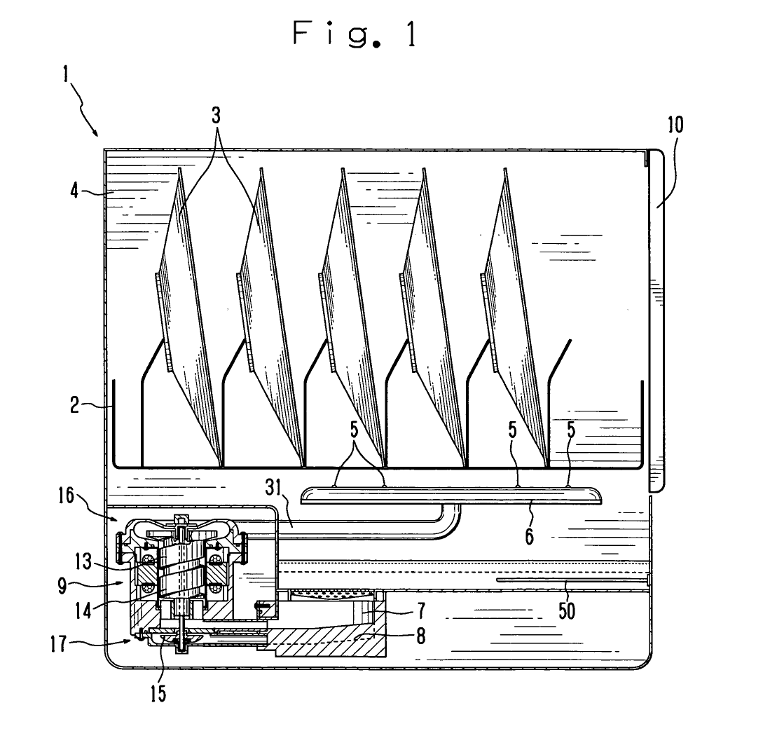

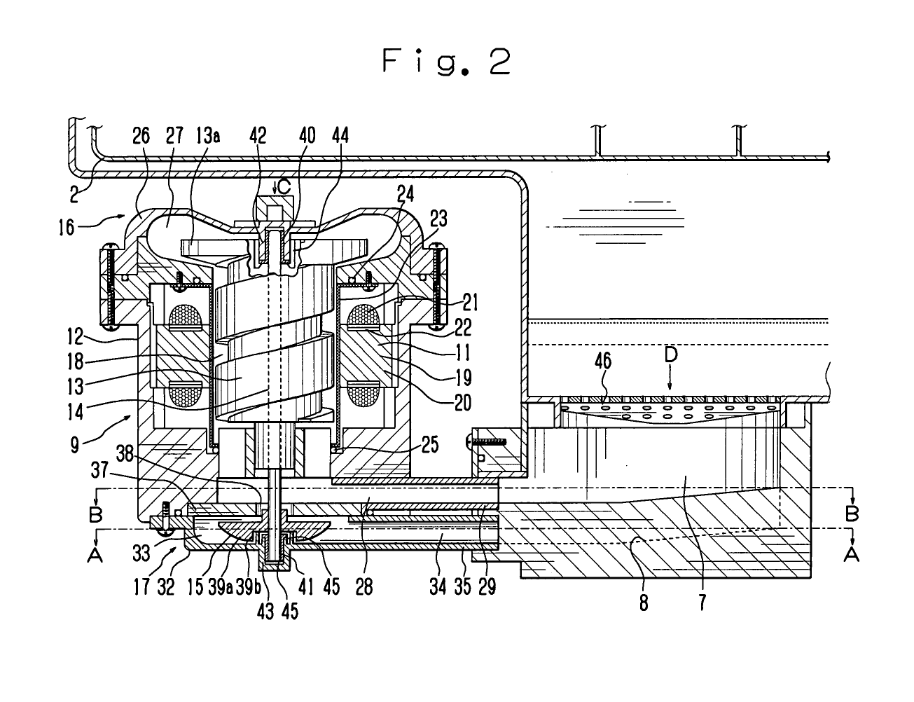

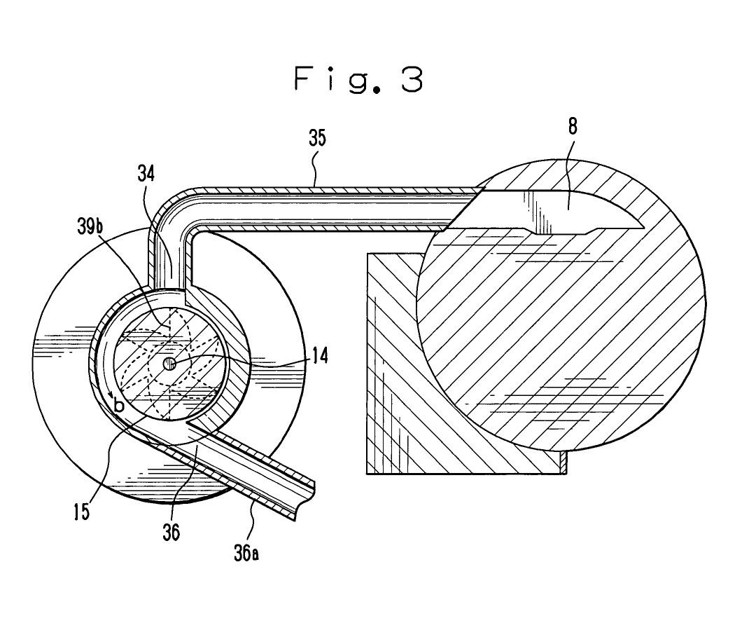

As shown in FIGS. 1 and 2, the bottom surface of the discharge tank 8 is positioned lower than the bottom surface of the washing water tank 7. The residua hole 48 is formed in a position communicating with the discharge tank 8. The residue which falls along the slope of the filter 46 therefore drops into the discharge tank 8 from the residua hole 48.

As shown in FIGS. 1 and 2, the bottom surface in the section from the second suction pipe 35 to the pump chamber 33, is at the same level or lower than the bottom surface of the discharge tank 8.

As shown in FIGS. 1 and 2, the bottom surface in the section from the first suction pipe 29 to the can 23, is at the same or lower level than the bottom surface of the washing water tank 7.

As shown in FIG. 1, a heater 50 to heat the washing water held in the washing water tank 7 to a set temperature is provided in the washing water tank 7.

In operation, when the dishes 3 are to be washed, these dishes 3 are placed in the dish basket 2 and set in the dish container 4. Next, a washing start button (not shown) is depressed. Depressing the washing start button triggers the supply of washing water to the washing water tank 7 and this supplied washing water is heated by the heater 50 automatically, under control of a controller (not shown). When the temperature of the washing water has risen to the set temperature, electrical current is supplied to the coil wire 21 of the stator 11 and the rotor 13 and the impeller 15 thereby start forward rotation (rotation in direction of the arrow a in FIG. 8) around the axis of the rotation shaft 14.

Along with the rotation of the rotor 13 and the impeller 15, the washing water which has entered the flow channel 18 of the rotor 13 rises along the flow channel 18. The washing water is then pressurized with the centrifugal impeller 13a and discharged from the outlet 30. As the washing water in the flow channel 18 rises, the washing water in the washing water tank 7 passes through the first suction pipe 29 and flows from the first suction port 28 into the can 23. The washing water that has flown from the washing water tank 7 into the can 23 also rises in the flow channel 18 and is discharged from the outlet 30. The washing water discharged from the outlet 30 flows through the supply pipe 31 is then supplied to the nozzle body 6, and ejected from the nozzles 5 of the nozzle body 6 toward the dishes 3. The dishes 3 are in this way washed.

The washing water discharged from the nozzles 5 washes the dishes 3 and then returns to the washing water tank 7. The washing water in the washing water tank 7 flows through the first suction pipe 29 then flows from the first suction port 28 into the can 23, and rises along the flow channel 18 of the rotor 13. The washing water then is again ejected from the nozzles 5 toward the dishes 3. The washing water in the washing water tank 7 is in this way circulated to wash the dishes 3. During washing of the dishes 3, a suction force from the outlet 30 prevents the washing water from being discharged from the discharge pipe 36a to outside the dish washer 1.

During washing of the dishes 3, the rotor 13 is forced downwards by the forward rotation of the rotor 13. A downward thrust load is thereby imposed on the rotation shaft 14. On the other hand, as the impeller 15 rotates forward along with the rotor 13, the washing water in the pump chamber 33 is pressed downward by the first pressing surface 39a of the blade 39. The pressing direction is the same as the direction of the thrust load acting on the rotation shaft 14. The counteraction from the downward depression of the washing water with the first pressing surface 39a therefore acts upwardly on the impeller 15. The upward counteraction offsets the downward thrust load acting on the rotation shaft 14. This reduces the load acting on the resin bearing 41 during washing, and the durability of the resin bearing 41 can be improved.

During washing of the dishes 3, the washing water is held in the reservoirs 44 and 45 provided around the resin bearings 40 and 41. The reserved washing water lubricates the resin bearings 40 and 41. Accordingly, the durability of the resin bearings 40 and 41 can be further improved. Since the resin bearings 40 and 41 are lubricated by the washing water held in the reservoirs 44 and 45, maintenance work to replenish the resin bearings 40 and 41 with lubricant is not required.

The residue washed from the dishes 3 during washing drops on the filter 46 and slides along the slope of the filter 46, and drops from the residua hole 48 into the discharge tank 8. The residue that dropped in the discharge tank 8 is prevented by the filter 46 from returning to the washing water tank 7 and remains in the discharge tank 8. The pump chamber 33 communicating with the discharge tank 8 and the can 23 communicating with the washing water tank 7 are connected by a communicating hole 38 formed in the partition plate 37. The residue that dropped into the discharge tank 8 can therefore pass through the communicating hole 38 and enter the can 23 (on the washing water tank 7 side). However, since the size of communicating hole 38 does not allow residue of a size that might clog the nozzles 5 to pass, the clogging of the nozzles 5 by residue that enters the can 23 (on the washing water tank 7 side) can be prevented.

After a predetermined period has elapsed after the start of washing of the dishes 3, the controller switches the electrical current flow pattern to the coil wire 21, and the rotor 13 and the impeller 15 start rotating in reverse (rotating in the arrow b direction in FIG. 8) around the axis of the rotation shaft 14.

As the impeller 15 rotates in reverse, the second pressing surface 39b of the impeller 15 collides against the washing water in the pump chamber 33 at an approximately right angle. The collision sends the washing water in the pump chamber 33 from the discharge port 36 into the discharge pipe 36a and the washing water is discharged outside the dish washer 1. As the pump chamber 33 communicates with the discharge tank 8 via the second suction pipe 35, the residue that dropped in the discharge tank is discharged along with the discharge of the washing water in the discharge tank 8.

As the rotor 13 rotates in reverse, the washing water in the supply pipe 31 and the pressure chamber 27 is guided along the flow channel 18 to the lower section and returned to the washing water tank 7. The washing water therefore does not remain in the supply pipe 31 and the pressure chamber 27. When the washing water has returned from the supply pipe 31 and the pressure chamber 27 to the washing water tank 7, the rotor 13 is now in idle status. At this time, there is almost no thrust load imposed on the rotation shaft 14 from the rotation of the rotor 13.

When the water level of the washing water in the washing water tank 7 is higher than the upper end of the rib 49, the washing water in the washing water tank 7 passes over the upper end of the rib 49, enters the discharge tank 8, and is discharged.

When the water level of the washing water in the washing water tank 7 is lower than the upper end of the rib 49, the washing water in the washing water tank 7 passes through the communicating hole 38 of the partition plate 37, enters the pump chamber 33, and is discharged. During discharging of the washing water, the washing water flows out to the discharge tank 8 without remaining in the washing water tank 7 since the bottom surface in the area from the first suction pipe 29 to the can 23 is at the same or lower level than the bottom surface of the washing water tank 7.

During discharging of the washing water, the washing water is discharged outside the dish washer 1 without remaining in the discharge tank 8, since the bottom surface in the area from the second suction pipe 35 to the pump chamber 33 is at the same or lower level than the bottom surface of the discharge tank 8. This prevents foreign odors from occurring due to residual washing water in the discharge tank 8.

When discharging is performed by the reverse rotation of the impeller 15, an upward thrust load acts on the rotation shaft 14 and imposes a load on the resin bearings 40 and 41. However, the thrust load is small compared to the downward thrust load during washing. The discharging time is also much shorter than the washing time. The upward thrust load on the rotation shaft 14 during discharging therefore is not a significant factor that might lower the durability of the resin bearings 40 and 41.

Obviously, numerous modifications and variations of the present invention are possible in light of the above teachings. It is therefore to be understood that within the scope of appended claims, the invention may be practiced otherwise than as specifically described herein.

What is claimed is:

1. A motor-integrated pump, comprising:
a cylindrical stator having a plurality of coil wires;
a first suction port communicating with one open side of the stator;
an outlet communicating with the other open side of the stator;
a rotation shaft rotatably supported by a pair of bearings to pass through inside the stator;
a rotor fixed to the rotation shaft and capable of rotating in forward and reverse directions within the stator;
a flow channel formed in a spiral shape on an outer peripheral surface of the rotor to suck fluid from the first suction port and discharge the fluid to the outlet along with the forward rotation of the rotor;
a pump chamber separated by a partition wall from the first suction port on one open side of the stator to surround the rotation shaft;
a second suction port communicating with the pump chamber;
a discharge port communicating with the pump chamber;
an impeller fixed to the rotation shaft in the pump chamber;
a first pressing surface provided on the impeller to press the fluid in the pump chamber in the same direction as a direction of a thrust load acting on the rotation shaft along with the forward rotation of the rotor; and
a second pressing surface provided on the impeller to suck fluid from the second suction port and discharge the fluid to the discharge port along with the reverse rotation of the impeller.

2. The motor-integrated pump according to claim 1, wherein the first suction port and the pump chamber communicate with each other via a communicating hole formed in the partition wall.

3. A washing apparatus, comprising:
a container to contain an object to be washed;
a nozzle body positioned below the container and provided with a plurality of nozzles for discharging the washing water;
a washing water tank positioned below the container;
a discharge tank positioned below the container;
a motor-integrated pump, comprising:
a cylindrical stator including a plurality of coil wires;
a first suction port communicating with a lower open side of the stator;
an outlet communicating with an upper open side of the stator;
a rotation shaft rotatably supported by a pair of bearings to pass through inside the stator;
a rotor fixed to the rotation shaft and capable of rotating in forward and reverse directions within the stator;
a flow channel formed in a spiral shape on an outer peripheral surface of the rotor to suck fluid from the first suction port and discharge the fluid to the outlet along with the forward rotation of the rotor;
a pump chamber separated by a partition wall from the first suction port on the one open side of the stator and surrounding the rotation shaft;
a second suction port communicating with the pump chamber;
a discharge port communicating with the pump chamber;
an impeller fixed to the rotation shaft in the pump chamber;
a first pressing surface provided on the impeller to press the fluid in the pump chamber in the same direction as a direction of a thrust load acting on the rotation shaft along with the forward rotation of the rotor;
a second pressing surface provided on the impeller to suction fluid from the second suction port and discharge the fluid to the discharge port along with the reverse rotation of the impeller;
a first suction pipe connecting the washing water tank with the first suction port;
a supply pipe connecting the outlet with the nozzle body; and
a second suction pipe connecting the discharge tank with the second suction port.

4. A washing apparatus according to claim 3, wherein the first suction port and the pump chamber communicate with each other via a communicating hole.

5. A washing apparatus according to claim 3, wherein the bearing is formed of resin,
and further comprising a reservoir to hold the washing water in an area including the connecting ends of the bearing and the rotation shaft.
